(19) United States
(12) Patent Application Publication
(10) Pub. No.: US 2009/0155159 A1
(43) Pub. Date: Jun. 18, 2009

(54) PROCESS FOR THE MANUFACTURE OF CARBON DISULPHIDE

(76) Inventors: Carolus Matthias Anna Maria Mesters, Amsterdam (NL); Ronald Jan Schoonebeek, Amsterdam (NL)

Correspondence Address: SHELL OIL COMPANY, P O BOX 2463, HOUSTON, TX, 772522463, US

(21) Appl. No.: 12/300,759

(22) PCT Filed: May 14, 2007
(86) PCT No.: PCT/EP2007/054610

§ 371 Date: Jan. 20, 2009

(30) Foreign Application Priority Data
May 16, 2006 (EP) 06114011.7

(51) Int. Cl. C01B 31/26

(52) U.S. Cl. 423/443

(57) ABSTRACT

The invention provides a process for the manufacture of carbon disulphide comprising supplying a feedstock comprising a hydrocarbonaceous compound to a reaction zone containing a liquid elemental sulphur phase and reacting, in the liquid sulphur phase, at a temperature in the range of from 350 to 750° C. and a pressure in the range of from 3 to 200 bar (absolute) and in the absence of a catalyst, the hydrocarbonaceous compound with elemental sulphur in the absence of molecular oxygen. The invention further provides the use of a liquid stream comprising carbon disulphide and hydrogen sulphide obtainable by such process for enhanced oil recovery.

The present invention provides a process for the manufacture of carbon disulphide and the use of a liquid stream comprising carbon disulphide and hydrogen sulphide obtainable by such process for enhanced oil recovery.

Carbon disulphide is typically manufactured by reacting a lower hydrocarbon with elemental sulphur that is in the vapour phase according to the reaction equation:

CₙH₂₍ₙ₊₁₎+(3n+1)S→nCS₂+(n+1)H₂S (1)

In GB 1,173,344 for example is disclosed a process for reacting vapour phase sulphur and propane in the absence of a catalyst under a pressure not exceeding 10 atmospheres in a reaction zone which is maintained at a temperature of 550 to 850° C.

In U.S. Pat. No. 3,087,788 is disclosed a process for producing carbon disulphide from hydrocarbon gas and vaporous sulphur in a non-catalytic reaction stage combined with, preferably followed by, a catalytic reaction stage, wherein both stages are operated at a pressure between 2 and 20 atmospheres and a temperature between 400 and 750° C.

It is also known to manufacture carbon disulphide by catalytically reacting liquid sulphur with a hydrocarbon. In U.S. Pat. No. 2,492,719 for example is disclosed a process for preparing carbon disulphide, wherein a suspension of catalyst in molten sulphur is contacted with a hydrocarbon gas at a temperature of approximately 500 to 700° C., under sufficient pressure to maintain the sulphur in liquid phase.

Carbon disulphide is known to be a suitable solvent for enhanced oil recovery by miscible flooding. In enhanced oil recovery by miscible flooding, a solvent for oil is introduced into an oil reservoir and driven through the reservoir to increase oil recovery from the reservoir beyond what can be achieved by conventional means. In U.S. Pat. No. 3,847,221 for example, the use of carbon disulphide for enhanced oil recovery from tar sands is disclosed.

It has now been found that carbon disulphide can be manufactured with an attractive yield by reacting liquid sulphur with a hydrocarbon in the absence of a catalyst.

Accordingly, the present invention provides a process for the manufacture of carbon disulphide comprising supplying a feedstock comprising a hydrocarbonaceous compound to a reaction zone containing a liquid elemental sulphur phase and reacting, in the liquid sulphur phase, at a temperature in the range of from 350 to 750° C. and a pressure in the range of from 3 to 200 bar (absolute) and in the absence of a catalyst, the hydrocarbonaceous compound with elemental sulphur in the absence of molecular oxygen.

An advantage of the process according to the invention is that it can be carried out in the absence of a catalyst.

Compared to the conventional vapour phase process for carbon disulphide production, the process according to the invention has the advantage that there is no need to vaporise the sulphur.

In the process according to the invention, a gaseous phase comprising carbon disulphide and hydrogen sulphide is obtained. The gaseous phase may also comprise unconverted hydrocarbonaceous compound and elemental sulphur. By subjecting the gaseous phase to a single or sequential condensation steps, a liquid stream comprising carbon disulphide and hydrogen sulphide is obtained from the process according to the invention that may suitably be used for enhanced oil recovery.

Accordingly, the present invention further provides the use of a liquid stream comprising carbon disulphide and hydrogen sulphide for enhanced oil recovery, the liquid stream being obtainable by a process as hereinabove defined.

In the process according to the invention, carbon disulphide is produced by reacting a hydrocarbonaceous compound with elemental sulphur in a reaction zone containing a liquid elemental sulphur phase. The reaction between hydrocarbonaceous compound and elemental sulphur is carried out in the liquid sulphur phase. The reactants are reacted with each other at a temperature in the range of from 350 to 750° C. and at a pressure sufficient to maintain a liquid elemental sulphur phase.

The reaction is suitably carried out in a standard chemical reactor, e.g. a tank reactor. Such a reactor usually comprises a vertical, tubular reactor. The length/diameter ratio may vary from 20/1 to 1/3, and is suitably between 10/1 and 1/1, e.g. between 5/1 and 1.5/1. The hydrocarbonaceous feedstock is introduced at the lower end of the reactor, at least at a level lower than the middle of the expanded liquid sulphur column. Preferably the hydrocarbonaceous feed is introduced into the lower third of the expanded liquid sulphur column, more preferably into the lower quarter, e.g. at 10% of the height of the expanded liquid sulphur column or even lower. The reaction between the hydrocarbonaceous feed and the sulphur takes place within the boundaries in the reactor of the expanded liquid sulphur phase. The process of the invention comprises fixed reactors, rotating reactors are not used.

A feedstock comprising a hydrocarbonaceous compound is supplied to the reaction zone containing the liquid elemental sulphur phase. Reference herein to a hydrocarbonaceous compound is to a compound having carbon and hydrogen atoms and, optionally, a smaller amount of heteroatoms such as oxygen, sulphur or nitrogen. The hydrocarbonaceous compound may be gaseous, liquid, or solid at the reaction conditions applied. Examples of suitable hydrocarbonaceous compounds are hydrocarbons, asphalthenes, mercaptans, thiophenes, and alkylpolysulphides. Preferably, the hydrocarbonaceous compound is gaseous at the reaction conditions applied.

Preferably, the hydrocarbonaceous compound is a hydrocarbon, more preferably a saturated or unsaturated aliphatic hydrocarbon, more preferably an aliphatic hydrocarbon with in the range of from 1 to 20 carbon atoms. Saturated hydrocarbons with 1 to 4 carbon atoms, in particular methane, ethane, and propane, are particularly suitable reactants in the process according to the invention.

In the process according to the invention, the hydrocarbonaceous compound and elemental sulphur react with each other. In case the hydrocarbonaceous compound is a saturated aliphatic hydrocarbon, the reaction is according to the overall reaction equation:

CₙH₂₍ₙ₊₁₎+(3n+1)S→nCS₂+(n+1)H₂S

The feedstock may comprise more than one hydrocarbonaceous compound. The feedstock may also comprise other compounds, for example hydrogen sulphide, carbon oxides, and inert gases such as nitrogen and helium. Examples of suitable feedstocks for the process according to the invention are natural gas, liquefied propane gas (LPG), atmospheric or vacuum distillates, heavy oil streams such as the residuum obtained after atmospheric and/or vacuum distillation of crude oil, mercaptan-containing off-gas from a mercaptan absorber. A particularly suitable hydrocarbonaceous compound-comprising feedstock is natural gas.

In the process according to the invention, the feedstock will typically be continually supplied to the reaction zone. In case the hydrocarbonaceous compound is solid at the reaction conditions applied, the feedstock is preferably supplied to the reaction zone by pre-mixing it with the liquid sulphur phase with which the reaction zone is to be filled. This may also be done in case of a hydrocarbonaceous compound that is liquid at the reaction conditions applied. Preferably, a liquid feedstock is continually supplied to the reaction zone.

In case of a gaseous feedstock, the process may be carried out in any reactor configuration suitable for gas-liquid contacting, typically by bubbling the gaseous reactants through a reactor filled with liquid sulphur. In order to prevent the formation of gas slugs, the reactor may contain solid contactors, for example a structured packing or gauzes. For a gaseous hydrocarbonaceous compound, the initial contact time of the hydrocarbonaceous compound with the liquid sulphur is preferably in the range of from 0.1 to 200 seconds. It will be appreciated that the optimal contact time will increase with the refractive nature of the hydrocarbonaceous compound. A hydrocarbonaceous compound that is solid at the reaction conditions applied will therefore generally require a longer contact time than a hydrocarbonaceous compound that is liquid at the reaction conditions applied and a liquid compound will require a longer contact time than a gaseous compound.

A stream of liquid make-up sulphur may be continuously supplied to the reaction zone. Alternatively, the elemental sulphur in the reaction zone is periodically refreshed. Usually the amount of liquid sulphur will comprise 10-90 vol % of the total reactor volume, preferably 20-80 vol %, more preferably 30-70 vol %.

The process according to the invention is carried out at a temperature in the range of from 350 to 750° C., preferably of from 400 to 700° C., more preferably of from 400 to 650° C., especially between 500 and 550° C.

The reactants are reacted with each other at a pressure that is sufficient to maintain a liquid elemental sulphur phase. Therefore, the pressure strongly depends on the reaction temperature. Preferably, the pressure is in the range of from 3 to 200 bar (absolute), more preferably of from 5 to 100 bar (absolute), even more preferably of from 5 to 30 bar (absolute).

In the process according to the invention, a gaseous phase mainly comprising carbon disulphide, hydrogen sulphide, and elemental sulphur is formed. In case a gaseous hydrocarbonaceous compound is used, the gaseous phase typically also comprises unconverted hydrocarbonaceous compound.

Preferably, the process according to the invention further comprises withdrawing the gaseous phase comprising carbon disulphide and hydrogen sulphide from the reaction zone and condensing at least part of the gaseous phase to obtain a liquid stream comprising carbon disulphide.

If the effluent of the reaction zone is a mixed liquid and gaseous effluent, such as may for example be the case if a liquid feedstock is supplied to the reaction zone, the gas and the liquid phases of the effluent will first be separated in a gas-liquid separator.

The withdrawn gaseous phase may be condensed to obtain a liquid stream comprising carbon disulphide. Preferably, the gaseous phase is subjected to sequential partial condensation steps to obtain a liquid stream with a higher concentration of carbon disulphide. Purification steps other than condensation may also be applied in order to obtain a liquid stream comprising carbon disulphide with the desired composition.

Preferably, the gaseous phase withdrawn from the reaction zone is first cooled at super-atmospheric pressure to a temperature at which elemental sulphur condenses whilst carbon disulphide and the other components remain in the sulphur-depleted vapour phase. The condensed sulphur may then be recycled to the reaction zone. The sulphur-depleted vapour phase may be condensed to obtain the liquid stream comprising carbon disulphide. It will be appreciated that the desired composition of the liquid stream comprising carbon disulphide will determine the condensation and/or further purification steps needed. For the conventional applications of carbon disulphide, for example its use as raw material for rayon production or as solvent, a high purity of carbon disulphide is desired. If the liquid stream is used for enhanced oil recovery, i.e. for injecting it in an oil reservoir for increasing the oil production from that reservoir, the liquid carbon disulphide stream may comprise substantial amounts of other components such as hydrogen sulphide and hydrocarbonaceous compounds.

The liquid stream comprising carbon disulphide that is formed in the process according to the invention is particularly suitable to be used in enhanced oil recovery, since the liquid stream typically comprises components other than carbon disulphide that do not need to be removed for this application. Therefore, the process according to the invention preferably further comprises injecting the liquid stream comprising carbon disulphide into an oil reservoir for enhanced oil recovery. The liquid stream comprising carbon disulphide may be mixed with other liquid components or streams before being injected into the oil reservoir.

Typically, the liquid stream comprising carbon disulphide obtainable by the process according to the invention will also comprise hydrogen sulphide dissolved in the carbon disulphide, usually in a concentration in the range of from 0.1 to 66 wt % hydrogen sulphide based on the weight of carbon disulphide. Such a liquid stream comprising carbon disulphide and hydrogen sulphide is particularly suitable for enhanced oil recovery. Therefore, the invention further provides the use of a liquid stream comprising carbon disulphide and hydrogen sulphide obtainable by the process according to the invention for enhanced oil recovery.

### EXAMPLES

In a quartz reactor tube (inner diameter 12 mm; length 40 mm) an amount of powdered elemental sulphur is loaded. The reactor is brought at a pressure of 10 bar (absolute) with a flow of nitrogen and the reactor is heated to a reaction temperature above 400° C. At the reaction temperature, the reactor tube was filled with a liquid sulphur column with a height of 15 cm. A gaseous mixture comprising a hydrocarbon (methane or ethane) was supplied to the bottom of the reactor. At the top of the reactor, a gaseous effluent was withdrawn. The composition of the gaseous effluent was analysed by gas chromatography. Seven different experiments were carried out.

In the Table, the reaction conditions and the results are given for experiments 1 to 7.

TABLE 1
Reaction conditions and results for experiments 1 to 7.

| | | feed composition | | flow | | |
|---|---|---|---|---|---|---|
| | | hc^{a}/H₂S/N₂ | T | rate^{b} | WHSV | hc conversion |
| experiment | hc^{a} | (% volume) | (° C.) | (Nl/hr) | (NL/kg S/hr) | (% mole) |
| 1 | methane | 18.8/—/81.1 | 486 | 2.6 | | 20.4 |
| 2 | ethane | 12.9/—/— | 420 | 2.4 | | 13.0 |
| 3 | methane | 60.3/—/37.8 | 413 | 2.7 | | 3.2 |
| 4 | methane | 60.3/—/37.8 | 475 | 2.7 | | 16.6 |
| 5 | methane | 59.8/—/40.2 | 517 | 2.8 | | 39.5 |
| 6 | methane | 50.7/9.1/40.2 | 520 | 2.5 | | 36.6 |
| 7 | methane | 61.3/—/38.7 | 505 | 2.5 | | 37.0 |

^{a}hc: hydrocarbon.
^{b}normal litres (litres at STP conditions, i.e. 0° C. and 1 atm.) feed gas mixture per hour.

1. A process for the manufacture of carbon disulphide comprising supplying a molecular oxygen-containing gas and a feedstock comprising a hydrocarbonaceous compound to a reaction zone containing a liquid elemental sulphur phase and reacting, in the liquid sulphur phase, at a temperature in the range of from 300 to 750° C., the hydrocarbonaceous compound with elemental sulphur to form carbon disulphide and hydrogen sulphide and oxidising at least part of the hydrogen sulphide formed to elemental sulphur and water.

2. A process according to claim 1, wherein the hydrocarbonaceous compound is reacted with elemental sulphur in the absence of a catalyst.

3. A process according to claim 1, wherein the feedstock comprises hydrogen sulphide.

4. A process according to claim 1, wherein the hydrocarbonaceous compound is a compound that is gaseous at the reaction conditions.

5. A process according to claim 1, wherein the hydrocarbonaceous compound is a hydrocarbon.

6. A process according to claim 1, wherein the number of oxygen molecules supplied to the reaction zone is less than 25% of the number of the hydrogen atoms in the hydrocarbonaceous compound and the hydrogen sulphide supplied to the reaction zone.

7. A process according to claim 1, wherein the temperature in the reaction zone is in the range of from 400 to 700° C.

8. A process according to claim 1, wherein the pressure in the reaction zone is in the range of from 3 to 200 bar (absolute).

9. A process according to claim 1, further comprising withdrawing a gaseous phase comprising carbon disulphide and steam from the reaction zone, condensing at least part of the gaseous phase to obtain a liquid stream comprising carbon disulphide.

10. (canceled)

11. A process according to claim 1, wherein the hydrocarbonaceous compound is a saturated or unsaturated aliphatic hydrocarbon.

12. A process according to claim 1, wherein the hydrocarbonaceous compound is an aliphatic hydrocarbon with up to 20 carbon atoms.

13. A process according to claim 1, wherein the hydrocarbonaceous compound is a saturated aliphatic hydrocarbon with up to 4 carbon atoms.

14. A process according to claim 1, wherein the temperature in the reaction zone is in the range of from 400 to 650° C.

15. A process according to claim 1, wherein the pressure in the reaction zone is in the range of from 5 to 100 bar (absolute).

16. A process according to claim 1, wherein the pressure in the reaction zone is in the range of from 5 to 30 bar (absolute).

17. A process according to claim 1, further comprising injecting the liquid stream comprising carbon disulphide into an oil reservoir for enhanced oil recovery.

18. A process according to claim 2, wherein the feedstock comprises hydrogen sulphide.

19. A process according to claim 2, wherein the hydrocarbonaceous compound is a compound that is gaseous at the reaction conditions.

20. A process according to claim 3, wherein the hydrocarbonaceous compound is a compound that is gaseous at the reaction conditions.
